(19) United States
(12) Patent Application Publication
(10) Pub. No.: US 2006/0150921 A1
(43) Pub. Date: Jul. 13, 2006

(54) Adjustable harness tether

(76) Inventor: Jeff Zinger, Orange, CA (US)

Correspondence Address: Karl M. Steins;Steins & Associates, Suite 120, 2333 Camino del Rio South, San Diego, CA, 92108, US

(21) Appl. No.: 11/033,671

(22) Filed: Jan. 11, 2005

(51) Int. Cl. A62B 35/00

(52) U.S. Cl. 119/770

(57) ABSTRACT

An Adjustable Harness Tether is disclosed. The tether provides parents with a safe, reliable device for assisting their small child with waling, standing, bike riding and virtually any other activity requiring the child to balance. The tether is made from a soft material, yet is also durable and long-lasting. The device further is easily donned and doffed from the child and has a pair of convenient handles with which the parent can assist, control and manage the child.

### BACKGROUND OF THE INVENTION

1. Field of the Invention

This invention relates generally to physical support and training devices and, more specifically, to an adjustable harness tether.

2. Description of Related Art

The first few years of a child's life are marked by many milestones, both physical and developmental. A first tooth, the first time that a child rolls over unassisted and the first time a baby takes solid food are but a few of the precious moments which mark the steady development of an infant child. For many parents, the first time that their child crawls is of special significance, as this new mobility is the first “step” many little ones take towards independence. Most babies learn to crawl at between 6 and 10 months of age; after they've developed the strength to sit upright on their own.

A child's first toddling steps can begin immediately after learning to crawl, or alternatively can take the child several months to master. As most parents know, a child's first steps often involve bumps and bruises, as the inexperienced walker can easily lose his or her balance and then fall. Unfortunately, these accidental mishaps can render the child frustrated and sore from the scrapes and bruises that they are subject to from falls on hard unforgiving surfaces.

What is needed, then, is a device that will aide parents in preventing injuries to their toddlers learning to walk.

### SUMMARY OF THE INVENTION

In light of the aforementioned problems associated with the prior devices and methods, it is an object of the present invention to provide an Adjustable Harness Tether. The tether should provide parents with a safe, reliable device for assisting their small child with walking, standing, bike riding and virtually any other activity requiring the child to balance. The tether should be made from a soft material, yet be durable and long-lasting. The device should be easily donned and doffed from the child to encourage its use. Finally, the tether should have a pair of convenient handles with which the parent can assist, control and manage the child.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the adjustable harness tether of the present invention;

FIGS. 2A and 2B are perspective views of two versions of cinching means of the device of FIG. 1;

FIG. 3 is another perspective view of the device of FIG. 1;

FIG. 4 is a perspective view of the device of FIGS. 1 and 3 in use with a toddler; and

FIG. 5 is a cutaway view of the elongate pad of the device of FIGS. 1, 3 and 4.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an Adjustable Harness Tether.

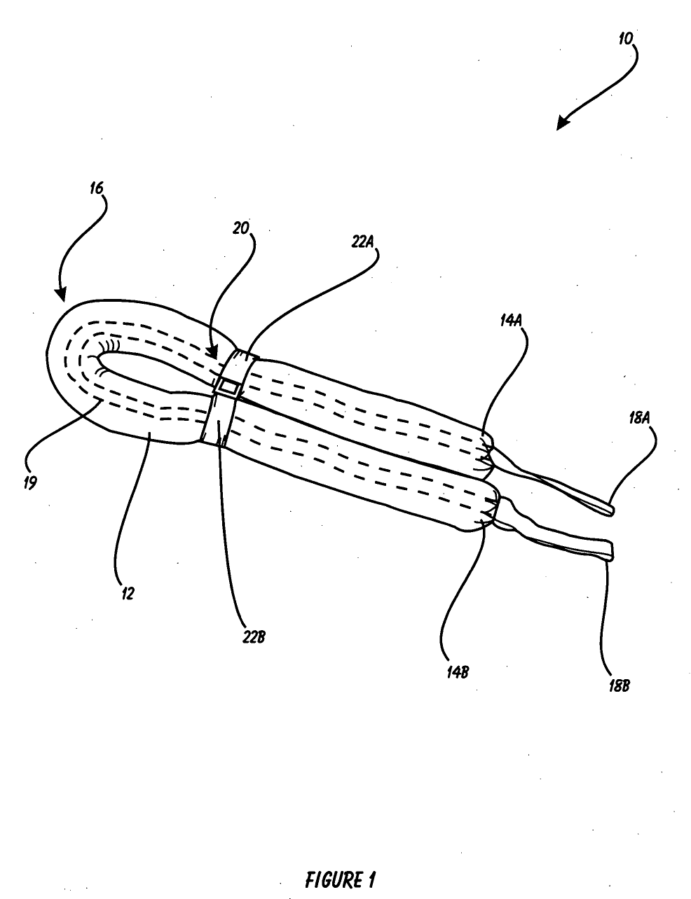

The present invention can best be understood by initial consideration of FIG. 1. FIG. 1 is a perspective view of a preferred embodiment of the adjustable harness tether of the present invention. The device 10 is a specially designed assistance apparatus comprised of a lightweight and comfortable harness to be worn around a child's chest. The device 10 comprises an elongate pad 12 defined by a first end 14A and a second end 14B, each being equidistant from the midpoint 16 of the pad 12. In the depicted version, the elongate pad 12 is approximately forty-four inches in length, and approximately seven inches in circumference.

A first handle 18A and second handle 18B extend from the respective ends 14A and 14B, and are preferably made from flexible webbing for comfort and durability. At a selected point along the elongate pad 12, a cinching means 20 is positioned. The cinching means 20 attaches to the pad 12 via a first loop assembly 22A and a second loop assembly 22B.

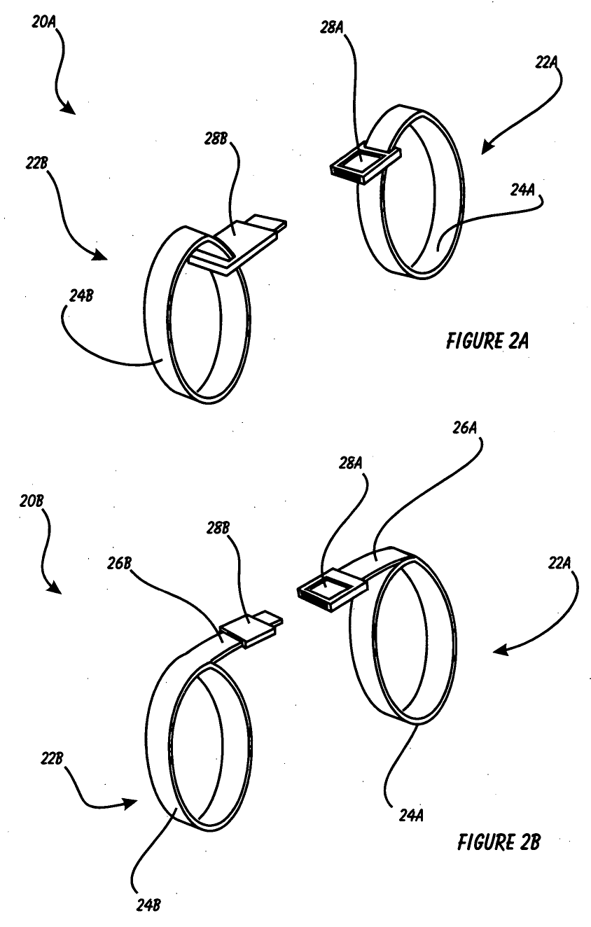

Depicted here in hidden lines is an internal reinforcing strap 19; this reinforcing strap may or may not be incorporated into the tether 10, depending upon the intended use for the device. If included, it will be made from a flexible, yet durable material such as woven mesh to provide increased strength to the tether. The specific details regarding the cinching means is more fully disclosed below in connection with FIGS. 2A and 2B.

FIG. 2A is a perspective view of the cinching means of the device of FIG. 1. Like the handles (see FIG. 1), the loop assemblies 22A and 22B are predominantly made from webbing material. The first loop assembly 22A comprises a first loop 24A, which passes through a slot formed in a first buckle half 28A. Similarly, the second loop assembly 22B comprises a second loop 24B and a second buckle half 28B. Since the buckle-halves are only attached to their respective loops via the loop passing through a slot formed in the halves, the buckle-halves can easily slide around the loops in order to assist in the interconnection of the halves when cinching the harness tether to a child.

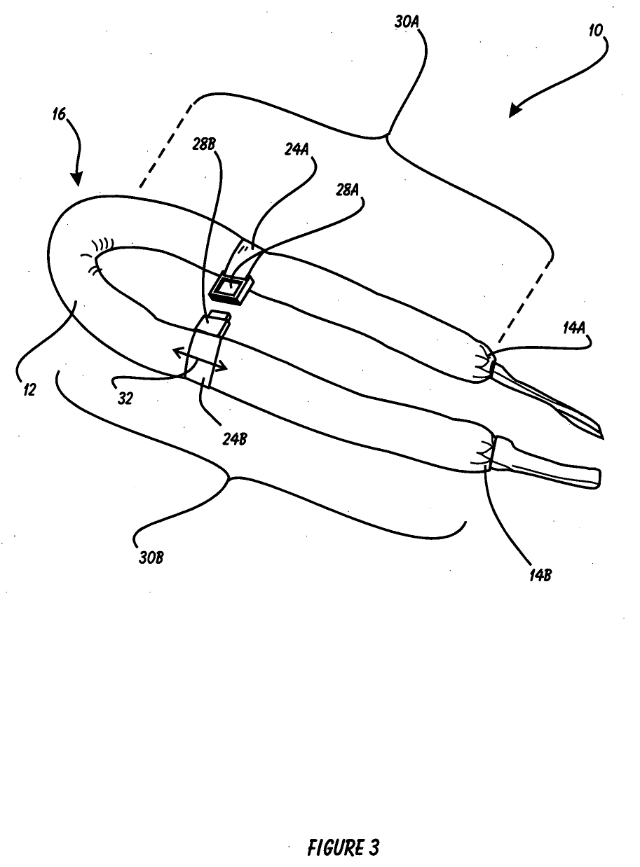

FIG. 2B is a perspective view of a second embodiment of the cinching means. The first loop assembly 22A comprises a first loop 24A, from which a first strap 26A extends and terminates in a first buckle-half 28A. Similarly, the second loop assembly 22B comprises a second loop 24B, from which a second strap 26B and second buckle-half 28B extends. As with the version of FIG. 2A, the loops 24A and 24B are sized slightly smaller than the elongate pad (see FIG. 1), so that will stay in place after they are slipped over the elongate pad and slid into a desired position. The two buckle halves 28A and 28B can be buckled together (as depicted in FIG. 1) once the device has been properly attached to the child. Turning to FIG. 3, we can see how the cinching means attaches to the device.

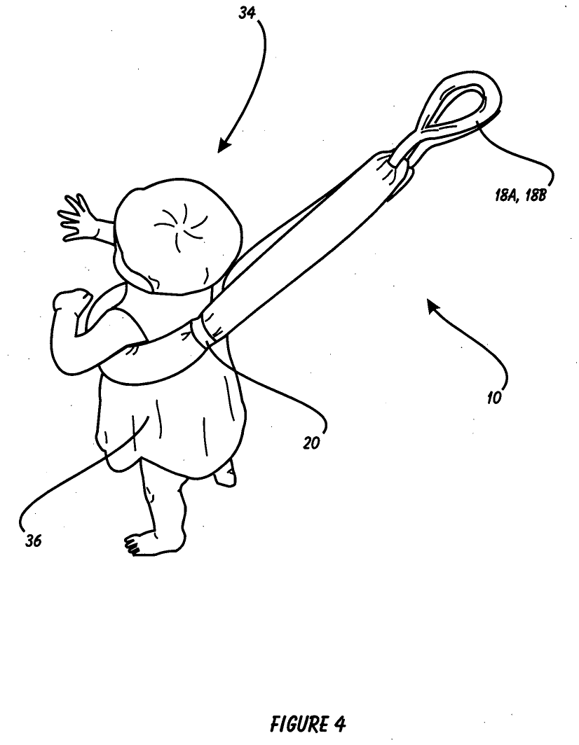

FIG. 3 is another perspective view of the device of FIG. 1. A first leg 30A and second leg 30B are defined as those portions of the elongate pad 12 between the midpoint 16 and the two ends 14A and 14B. In this drawing figure, the first loop 24A has been slipped over the first leg 30A; the second loop 24B has been slipped over the second leg 30B. Once slipped into the proper location, the loops 24A and 24B can be slid in adjustment direction 32 until they are the proper distance from the midpoint 16 to be correctly sized for the child's chest. Once adjusted, the device 10 can be attached to the child for use, as depicted in FIG. 4.

FIG. 4 is a perspective view of the device of FIGS. 1 and 3 in use with a toddler 34. As shown here, the cinching means 20 has been buckled around the child's chest/torso 36. The use of the tether 10 is fairly simple and straightforward. First, the parent (or other guardian of the subject to be tethered) positions the midpoint 16 of the device 10 so that it rests comfortably against the child's chest 36 and/or stomach. Next, the parent secures the device 10 in place via the cinching means 20; securing the buckle-halves together so that the cinching means 20 resides near the child's back, directly below the shoulder blades. For the typically-sized toddler, the cinching means 20 is best positioned approximately fifteen to twenty inches from the ends 14A and 14B. Adjustments to the cinching means 20 can continue to be made after the tether 10 is attached to the child 34.

Once the device 10 is properly secured about the child, with the two legs 30A and 30B positioned directly below each of the child's underarms, the parent simply needs to grasp the two handles 18A, 18B; this allows the parent to support and control the child 34 from behind while the child 34 is walking, standing, riding a bike, ice skating, etc.; virtually during any activity requiring the child to use their balance.

While tending to the child, the parent may wish to keep the handles 18A and 18B separated in order to exert two-handed control of the child 34. By offering complete and secure support to the toddler as they attempt to walk, the device effectively prevents the toddler from toppling over and accidentally slipping and falling when taking their first tentative steps. The device 10 is designed to support the weight of the child completely, thus enabling the parent to comfortably follow behind the child, without causing physical strain to themselves.

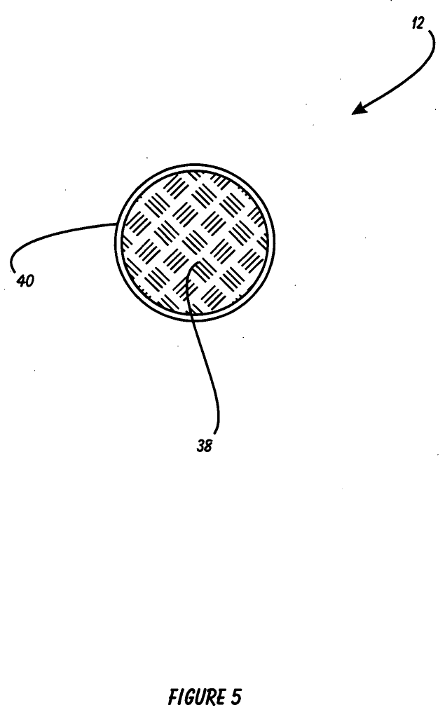

The device 10 could prove particularly useful to parents of children that suffer from physical or mental limitations which impede the child's ability to walk on his or her own. By enabling a parent to provide loving assistance to their child, the device could also provide both a practical safety device in addition to being an effective therapy tool for use in strengthening muscles and encouraging independence. Similarly, the device 10 could provide very useful to parents suffering from degraded mobility, such as back pain and the like, which may impede the parents' mobility to bend or stoop to protect the toddler. Finally turning to FIG. 5, we can take a look at the composition of the invention.

FIG. 5 is a cutaway view of the elongate pad of the device of FIGS. 1, 3 and 4. The device is manufactured with a center filling 38 primarily made of quilt batting, padded foam material, or pillow stuffing, encased in a soft, machine-washable fabric covering 40. In other versions, the cover may be made from waterproof material such that the device can be used to tend a child attempting to swim. The elongate pad could be manufactured in a variety of attractive colors and/or printed designs.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An adjustable harness tether, comprising:
an elongate pad comprising a midpoint, a first leg extending from said midpoint and terminating in a first end; a second leg extending from said midpoint and terminating in a second end;
a first handle extending from said first end;
a second handle extending from said second end; and
cinching means attached to said pad to operatively cinch said first leg to said second leg.

2. The tether of claim 1, wherein said elongate pad comprises a soft, foam center filling encased in a pliable cover.

3. The tether of claim 2, wherein said pliable cover is substantially waterproof.

4. The tether of claim 2, wherein:
said elongate pad defines a pad diameter; and
said cinching means comprises:
a first loop slipped over said first leg;
a second loop slipped over said second leg, said first and second loops defining diameters sufficient to snugly slip over said respective first and second legs.

5. The tether of claim 4, wherein said first securing means comprises a first buckle-half and said second securing means comprises a second buckle-half.

6. The tether of claim 5, wherein said elongate pad is further defined by a reinforcing strap encased within said pliable cover and extending from said first handle to said second handle.

7. A harness tether for toddlers, comprising:
an elongate pad comprising a midpoint, a first leg extending from said midpoint and terminating in a first end; a second leg extending from said midpoint and terminating in a second end; and
cinching means attached to said pad to operatively cinch said first leg to said second leg.

8. The harness tether of claim 7, wherein:
said elongate pad defines a pad diameter; and
said cinching means comprises:
a first loop slipped over said first leg;
a second loop slipped over said second leg, said first and second loops defining diameters sufficient to snugly slip over said respective first and second legs.

9. The harness tether of claim 8, wherein said cinching means further comprises:
a first strap extending from said first loop;
a second strap extending from said second loop;
a first securing means extending from said first strap; and
a second securing means extending from said second strap.

10. The harness tether of claim 9, wherein said first securing means comprises a first buckle-half and said second securing means comprises a second buckle-half.

11. The harness tether of claim 10, further comprising a first handle extending from said first end of said elongate pad, and a second handle extending from said second end of said elongate pad.

12. The harness tether of claim 11, wherein said elongate pad comprises a soft, foam center filling encased in a pliable cover.

13. The harness tether of claim 12, wherein said pliable cover is substantially waterproof.

14. A tethering device, comprising:
an elongate pad defining a pad diameter and comprising a midpoint, a first leg extending from said midpoint and terminating in a first end; a second leg extending from said midpoint and terminating in a second end; and
cinching means attached to said pad to operatively cinch said first leg to said second leg, said cinching means comprising:
a first loop slipped over said first leg;
a second loop slipped over said second leg, said first and second loops defining loop diameters sufficiently larger than said pad diameter to snugly slip over said respective first and second legs.

15. The device of claim 14, wherein said cinching means further comprises:
a first strap extending from said first loop;
a second strap extending from said second loop;
a first securing means extending from said first strap; and
a second securing means extending from said second strap.

16. The device of claim 15, wherein said first securing means comprises a first buckle-half and said second securing means comprises a second buckle-half.

17. The device of claim 16, further comprising a first handle extending from said first end of said elongate pad, and a second handle extending from said second end of said elongate pad.

18. The device of claim 17, wherein said elongate pad comprises a soft, foam center filling encased in a pliable cover.

19. The device of claim 18, wherein said pliable cover is substantially waterproof.

20. The tether of claim 4, wherein said cinching means further comprises:
a first strap extending from said first loop;
a second strap extending from said second loop;
a first securing means extending from said first strap; and
a second securing means extending from said second strap.
